(19) United States
(12) Patent Application Publication
(10) Pub. No.: US 2015/0081700 A1
(43) Pub. Date: Mar. 19, 2015

(54) DATA ROUTING METHOD IN WIRELESS SENSOR NETWORK, BASE STATION NODE AND WIRELESS SENSOR NETWORK

(71) Applicants: Graduate School at Shenzhen, Tsinghua University, Shenzhen (CN); Tsinghua University, Beijing (CN)

(72) Inventors: KE XU, Shenzhen (CN); LONG YAO, Shenzhen (CN); WENLONG CHEN, Shenzhen (CN)

(21) Appl. No.: 14/485,768

(22) Filed: Sep. 14, 2014

(30) Foreign Application Priority Data
Sep. 17, 2013 (CN) 201310425307.1

(51) Int. Cl. G06F 17/30; G01D 21/00; H04L 29/08

(52) U.S. Cl. CPC G06F 17/30386; H04L 67/10; G01D 21/00
USPC 707/736; 707/769

(57) ABSTRACT

A data routing method in a wireless sensor network, a base station node, and a wireless sensor network are provided. The data routing method comprises: establishing a routing table for a base station node in the wireless sensor network, in which the routing table comprises a plurality of data types and a plurality of destination addresses corresponding to the plurality of data types; receiving a search request by the base station node, and searching for the destination address corresponding to the search request in the routing table according to the search request; determining a memory corresponding to the destination address and obtaining target data satisfying the search request from the memory; and feeding back the target data to the base station node from the memory.

### CROSS-REFERENCE TO RELATED APPLICATION

This application claims priority to and benefits of Chinese Patent Application Serial No. 201310425307.1, filed with the State Intellectual Property Office of P. R. China on Sep. 17, 2013, the entire content of which is incorporated herein by reference.

### FIELD

The present disclosure relates to a wireless communication field, and more particularly to a data routing method in a wireless sensor network, a base station node and a wireless sensor network.

### BACKGROUND

With the rapid development of network technique, information and content are used more for sharing and cooperating, rather than being transmitted from one address to another destination address. Thus, conventional network access methods based on end-to-end addressing have many shortcomings. In this context, a network architecture system designed on a basis of “convenient access to content” (i.e. a content-centric network) is produced.

The content-centric network mainly focuses on supporting existing typical applications and content access better. Since the user only cares about the required content and information and don't care about the storing location and transmission mode of the content and information (for example, things done by ISP (Internet Service Provider) and ICP (Internet Content Provider)), the architecture of the content-centric network is an information-centric model (taking the resource-sharing communication into account) rather than a session model. However, the existing communication modes always follow certain norms and standards. Thus, there is a need to design an effective and flexible content-based data routing method.

### SUMMARY

Embodiments of the present disclosure seek to solve at least one of the problems existing in the related art to at least some extent.

According to a first aspect of the present disclosure, a data routing method in a wireless sensor network is provided. The method comprises: establishing a routing table for a base station node in the wireless sensor network, wherein the routing table comprises a plurality of data types and a plurality of destination addresses corresponding to the plurality of data types; receiving a search request by the base station node, and searching for the destination address corresponding to the search request in the routing table according to the search request; determining a memory corresponding to the destination address according to the destination address corresponding to the search request, and obtaining target data satisfying the search request from the memory; and feeding back the target data to the base station node from the memory.

In some embodiments, each destination address in the routing table is corresponding to one memory, and each memory comprises at least one type of data.

In some embodiments, the wireless sensor network comprises a plurality of types of sensors for collecting a plurality of types of data.

In some embodiments, the data collected by each type of sensor is stored in the memory corresponding to the destination address of the data according to the routing table.

In some embodiments, the plurality of data types comprises temperature, humidity, air pressure, wind power, illumination intensity, ultraviolet intensity, carbon dioxide concentration, air pollution index, toxic gas, noise, pressure, vibration, strain, displacement, velocity, heavy metal content, radiation value, electromagnetic radiation value, body temperature, blood pressure, heart rate, oxygen saturation, PH value and water soluble ion concentration.

With the data routing method according to embodiments of the present disclosure, by establishing the routing table comprising many properties, content data transmission in the wireless sensor network can be achieved.

According to a second aspect of the present disclosure, a base station node is provided. The base station node comprises: an establishing module, configured to establish a routing table for the base station node, wherein the routing table comprises a plurality of data types and a plurality of destination addresses corresponding to the plurality of data types; a request receiving module, configured to receive a search request; a searching module, configured to search for the destination address corresponding to the search request in the routing table according to the search request; a determining module, configured to determine a memory corresponding to the destination address according to the destination address corresponding to the search request; and a data receiving module, configured to receive target data satisfying the search request from the memory.

In some embodiments, each destination address in the routing table is corresponding to one memory, and each memory comprises at least one type of data.

In some embodiments, the plurality of data types comprises temperature, humidity, air pressure, wind power, illumination intensity, ultraviolet intensity, carbon dioxide concentration, air pollution index, toxic gas, noise, pressure, vibration, strain, displacement, velocity, heavy metal content, radiation value, electromagnetic radiation value, body temperature, blood pressure, heart rate, oxygen saturation, PH value and water soluble ion concentration.

With the base station node according to embodiments of the present disclosure, by establishing the routing table comprising many properties, content data transmission in a wireless sensor network can be achieved.

According to a third aspect of the present disclosure, a wireless sensor network is provided. The wireless sensor network comprises a base station node and a plurality of memories. The base station node is configured to store a routing table comprising a plurality of data types and a plurality of destination addresses corresponding to the plurality of data types, to receive a search request, to search for the destination address corresponding to the search request in the routing table according to the search request, to determine a memory corresponding to the destination address according to the destination address corresponding to the search request, and to receive target data satisfying the search request fed back from the memory. Each memory is configured to store at least one type of data, to obtain the target data satisfying the search request, and to feed back the target data to the base station node.

In some embodiments, the base station node comprises: a storing module, configured to store the routing table; a request receiving module, configured to receive the search request; a searching module, configured to search for the destination address corresponding to the search request in the routing table according to the search request; a determining module, configured to determine the memory corresponding to the destination address according to the destination address corresponding to the search request; and a data receiving module, configured to receive target data satisfying the search request from the memory.

In some embodiments, each destination address in the routing table is corresponding to one memory.

In some embodiments, the wireless sensor network further comprises a plurality of types of sensors for collecting a plurality of types of data.

In some embodiments, the data collected by each type of sensor is stored in the memory corresponding to the destination address of the data according to the routing table.

In some embodiments, the plurality of data types comprises temperature, humidity, air pressure, wind power, illumination intensity, ultraviolet intensity, carbon dioxide concentration, air pollution index, toxic gas, noise, pressure, vibration, strain, displacement, velocity, heavy metal content, radiation value, electromagnetic radiation value, body temperature, blood pressure, heart rate, oxygen saturation, PH value and water soluble ion concentration.

With the wireless sensor network according to embodiments of the present disclosure, by establishing the routing table comprising many properties for the base station nodes, content data transmission in the wireless sensor network can be achieved.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a flow chart of a data routing method in a wireless sensor network according to embodiments of the present disclosure;

FIG. 2 is a schematic diagram illustrating a data routing in a wireless sensor network;

FIG. 3 is a block diagram of a base station node according to embodiments of the present disclosure;

FIG. 4 is a block diagram of a wireless sensor network according to an embodiment of the present disclosure;

FIG. 5 is a block diagram of a wireless sensor network according to another embodiment of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

In the specification, unless specified or limited otherwise, relative terms such as “central”, “longitudinal”, “lateral”, “front”, “rear”, “right”, “left”, “inner”, “outer”, “lower”, “upper”, “horizontal”, “vertical”, “above”, “below”, “up”, “top”, “bottom” as well as derivative thereof (e.g., “horizontally”, “downwardly”, “upwardly”, etc.) should be construed to refer to the orientation as then described or as shown in the drawings under discussion. These relative terms are for convenience of description and do not require that the present disclosure be constructed or operated in a particular orientation.

In the description of the present disclosure, it should be understood that, unless specified or limited otherwise, the terms “mounted,” “connected,” and “coupled” and variations thereof are used broadly and encompass such as mechanical or electrical mountings, connections and couplings, also can be inner mountings, connections and couplings of two components, and further can be direct and indirect mountings, connections, and couplings, which can be understood by those skilled in the art according to the detail embodiment of the present disclosure.

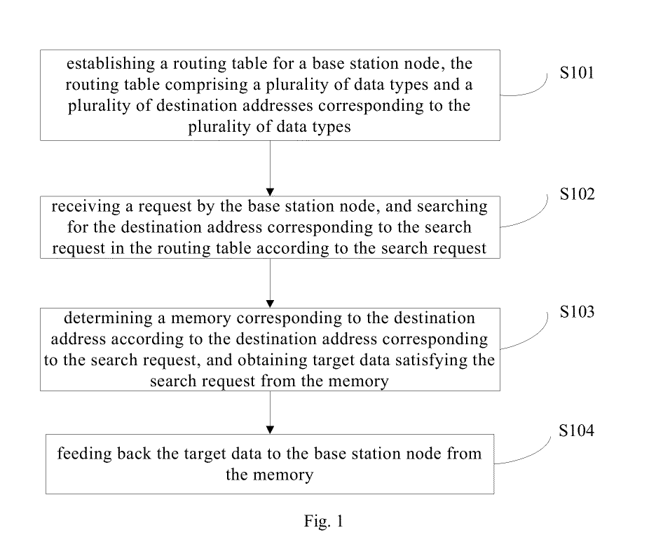

According to embodiments of the present disclosure, a data routing method in a wireless sensor network is provided. As shown in FIG. 1, the method includes following steps.

At step S1, a routing table is established in a base station node of the wireless sensor network. The routing table comprises a plurality of data types and a plurality of destination addresses corresponding to the plurality of data types.

In one embodiment of the present disclosure, the routing table established in the base station node is as shown in Table I.

TABLE I

| Type | Destination address |
|---|---|
| Physical quantities 1 | Address 1 |
| Physical quantities 2 | Address 2 |
| Physical quantities 3 | Address 3 |
| Physical quantities 4 | Address 4 |
| Physical quantities 5 | Address 1 |
| . . . | . . . |

In some embodiments of the present disclosure, each destination address in the routing table is corresponding to one memory, and each memory stores a plurality of types of data. Furthermore, the wireless sensor network may comprise a plurality of types of sensors for collecting a plurality of types of data and storing the collected data in corresponding memories. Specifically, one memory may store one type of data or a plurality of types of data. For example, a memory may store temperature data, humidity data and air pressure data, or may only store the temperature data and the humidity data. Since the number of memories is limited, the number of types of data in one memory can be defined according to the number of memories and the number of types of data collected by the sensors.

In one embodiment, the plurality of data types comprises temperature, humidity, air pressure, wind power, illumination intensity, ultraviolet intensity, carbon dioxide concentration, air pollution index, toxic gas, noise, pressure, vibration, strain, displacement, velocity, heavy metal content, radiation value, electromagnetic radiation value, body temperature, blood pressure, heart rate, oxygen saturation, PH value and water soluble ion concentration.

At step S2, the base station node receives a search request and searches for the destination address corresponding to the search request in the routing table according to the search request. The search request may be from a user.

At step S3, the memory corresponding to the destination address is determined according to the destination address corresponding to the search request, and target data satisfying the search request is obtained from the memory.

At step S4, the target data is fed back from the memory to the base station node.

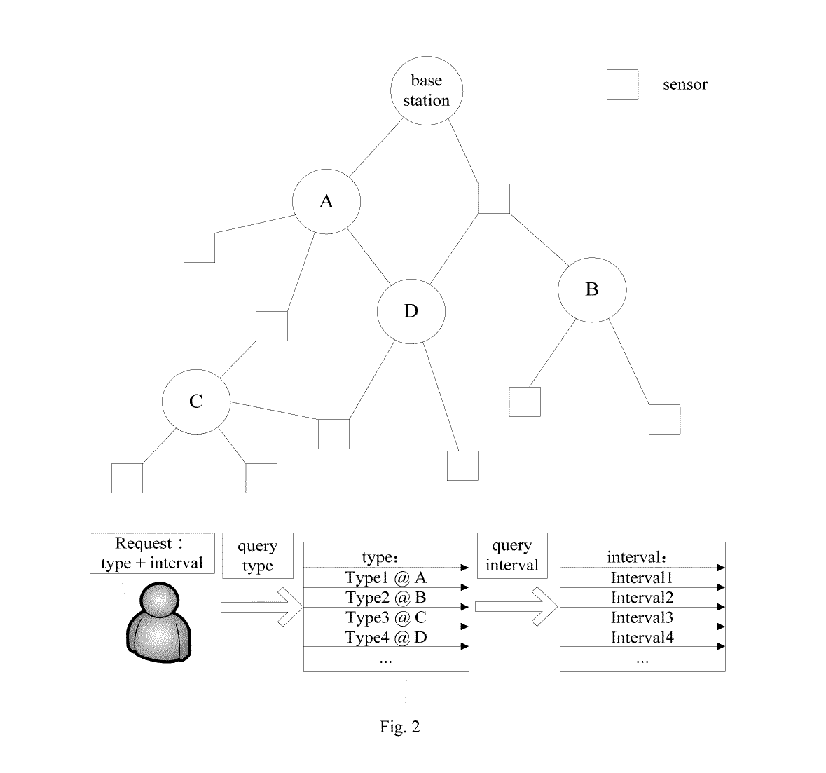

FIG. 2 is a schematic diagram illustrating a data routing in the wireless sensor network according to an embodiment of the present disclosure. As shown in FIG. 2, the wireless sensor network comprises a plurality of sensors for collecting different types of data and the collected data are stored in four memories (memory A, memory B, memory C, and memory D). The memory A is used for storing temperature data and air pressure data, the memory B is used for storing humidity data, the memory C is used for storing air pollution indexes, and the memory D is used for storing noise decibel values. The routing table is established in the base station node. Supposing that the user requests to search for temperature data whose temperature is higher than 32 degrees Celsius and humidity data whose humidity is higher than 75%, the search request is sent to the base station node (i.e. sink node), and the sink node firstly search the routing table according to the physical quantities in the search request to obtain the destination address (i.e. the memory address). For example, the addresses of memory A and memory B are obtained. Then, data satisfying the search request are obtained from memory A and memory B, i.e. the temperature data whose temperature is higher than 32 degrees Celsius is obtained from memory A, and the humidity data whose humidity is higher than 75% is obtained from memory B. Finally, the data satisfying the search request is fed back to the sink node.

With the data routing method according to the present disclosure, by establishing the routing table comprising many quantities, the content data transmission in the wireless sensor network can be achieved.

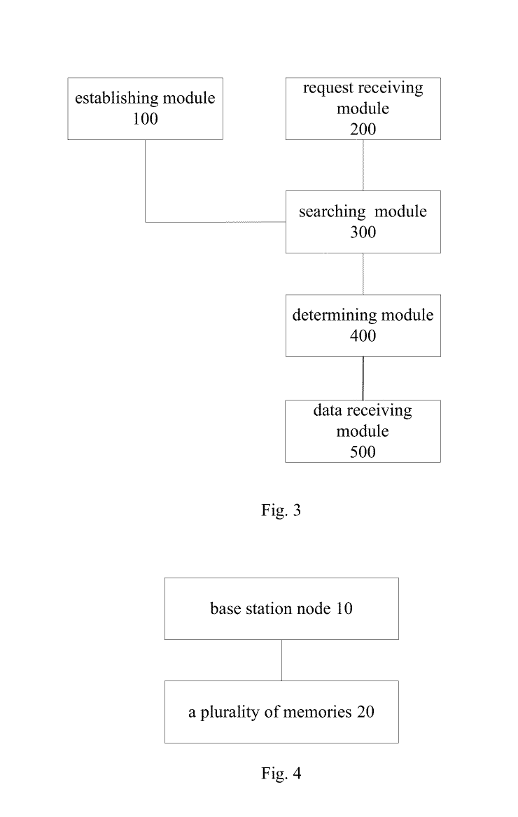

FIG. 3 is a block diagram of a base station node according to an embodiment of the present disclosure. As shown in FIG. 3, the base station node comprises an establishing module 100, a request receiving module 200, a searching module 300, a determining module 400 and a data receiving module 500.

The establishing module 100 is configured to establish a routing table for the base station node. The routing table comprises a plurality of data types and a plurality of destination addresses corresponding to the plurality of data types.

In one embodiment of the present disclosure, each destination address in the routing table is corresponding to one memory, and the plurality of types of data is stored in memories. The plurality of data types comprises temperature, humidity, air pressure, wind power, illumination intensity, ultraviolet intensity, carbon dioxide concentration, air pollution index, toxic gas, noise, pressure, vibration, strain, displacement, velocity, heavy metal content, radiation value, electromagnetic radiation value, body temperature, blood pressure, heart rate, oxygen saturation, PH value and water soluble ion concentration.

One memory may store one type of data or a plurality of types of data. For example, a memory may store temperature data, humidity data and air pressure data, or may only store the temperature data and the humidity data. Since the number of memories is limited, the number of types of data in one memory can be defined according to the number of memories and the number of types of data collected by the sensors.

The request receiving module 200 is configured to receive a search request. The search request may be from a user.

The searching module 300 is configured to search for the destination address corresponding to the search request in the routing table according to the search request.

The determining module 400 is configured to determine a memory corresponding to the destination address according to the destination address corresponding to the search request.

The data receiving module 500 is configured to receive target data satisfying the search request from the memory.

With the base station node according to embodiments of the present disclosure, by establishing the routing table comprising many properties, the content data transmission in the wireless sensor network can be achieved.

FIG. 4 is a block diagram of a wireless sensor network according to an embodiment of the present disclosure. As shown in FIG. 4, the wireless sensor network comprises a base station node 10 and a plurality of memories 10.

The base station node 10 is configured to store a routing table comprising a plurality of data types and a plurality of destination addresses corresponding to the plurality of data types, to receive a search request, to search for the destination address corresponding to the search request in the routing table according to the search request, to determine a memory corresponding to the destination address according to the destination address corresponding to the search request, and to receive target data satisfying the search request fed back from the memory.

Each memory 20 is configured to store at least one type of data, to obtain the target data satisfying the search request, and to feed back the target data to the base station node.

In one embodiment of the present disclosure, the base station node 10 may comprise a storing module, a request receiving module, a searching module, a determining module and a data receiving module. The storing module is configured to store the routing table. The request receiving module is configured to receive the search request. The search request may be from a user. The searching module is configured to search for the destination address corresponding to the search request in the routing table according to the search request. The determining module is configured to determine the memory corresponding to the destination address according to the destination address corresponding to the search request. The data receiving module is configured to receive the target data satisfying the search request from the memory.

In some embodiments of the present disclosure, each destination address in the routing table is corresponding to one memory.

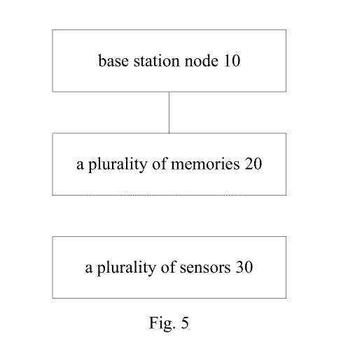

FIG. 5 is a block diagram of a wireless sensor network according to another embodiment of the present disclosure. As shown in FIG. 5, the wireless sensor network may further comprise a plurality of sensors 30. The plurality of sensors 30 is configured to collect a plurality of types of data. The plurality of sensors 30 is of different types. For example, sensor I is used for collecting temperature data, and sensor II is used for collecting humidity data.

The data collected by each type of sensor is stored in the memory corresponding to the destination address of the data according to the routing table. For example, if the temperature data is corresponding to address 1 in the routing table, the collected temperature data is stored in the memory corresponding to the address 1.

In some embodiments, the plurality of data types comprises temperature, humidity, air pressure, wind power, illumination intensity, ultraviolet intensity, carbon dioxide concentration, air pollution index, toxic gas, noise, pressure, vibration, strain, displacement, velocity, heavy metal content, radiation value, electromagnetic radiation value, body temperature, blood pressure, heart rate, oxygen saturation, PH value and water soluble ion concentration.

With the wireless sensor network according to embodiments of the present disclosure, by establishing the routing table comprising many properties, the content data transmission in the wireless sensor network can be achieved.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A data routing method in a wireless sensor network, comprising:
establishing a routing table for a base station node in the wireless sensor network, wherein the routing table comprises a plurality of data types and a plurality of destination addresses corresponding to the plurality of data types;
receiving a search request by the base station node, and searching for the destination address corresponding to the search request in the routing table according to the search request;
determining a memory corresponding to the destination address according to the destination address corresponding to the search request and obtaining target data satisfying the search request from the memory; and
feeding back the target data to the base station node from the memory.

2. The method according to claim 1, wherein each destination address in the routing table is corresponding to one memory, and each memory comprises at least one type of data.

3. The method according to claim 1, wherein the wireless sensor network comprises a plurality of types of sensors for collecting a plurality of types of data.

4. The method according to claim 3, wherein the data collected by each type of sensor is stored in the memory corresponding to the destination address of the data according to the routing table.

5. The method according to claim 1, wherein the plurality of data types comprises temperature, humidity, air pressure, wind power, illumination intensity, ultraviolet intensity, carbon dioxide concentration, air pollution index, toxic gas, noise, pressure, vibration, strain, displacement, velocity, heavy metal content, radiation value, electromagnetic radiation value, body temperature, blood pressure, heart rate, oxygen saturation, PH value and water soluble ion concentration.

6. A base station node, comprising:
an establishing module, configured to establish a routing table for the base station node, wherein the routing table comprises a plurality of data types and a plurality of destination addresses corresponding to the plurality of data types;
a request receiving module, configured to receive a search request;
a searching module, configured to search for the destination address corresponding to the search request in the routing table according to the search request;
a determining module, configured to determine a memory corresponding to the destination address according to the destination address corresponding to the search request; and
a data receiving module, configured to receive target data satisfying the search request from the memory.

7. The base station node according to claim 6, wherein each destination address in the routing table is corresponding to one memory, and each memory comprises at least one type of data.

8. The base station node according to claim 6, wherein the plurality of data types comprises temperature, humidity, air pressure, wind power, illumination intensity, ultraviolet intensity, carbon dioxide concentration, air pollution index, toxic gas, noise, pressure, vibration, strain, displacement, velocity, heavy metal content, radiation value, electromagnetic radiation value, body temperature, blood pressure, heart rate, oxygen saturation, PH value and water soluble ion concentration.

9. A wireless sensor network, comprising:
a base station node, configured to store a routing table comprising a plurality of data types and a plurality of destination addresses corresponding to the plurality of data types, to receive a search request, to search for the destination address corresponding to the search request in the routing table according to the search request, to determine a memory corresponding to the destination address according to the destination address corresponding to the search request, and to receive target data satisfying the search request fed back from the memory; and
a plurality of memories, wherein each memory is configured to store at least one type of data, to obtain the target data satisfying the search request, and to feed back the target data to the base station node.

10. The wireless sensor network according to claim 9, wherein the base station node comprises:
a storing module, configured to store the routing table;
a request receiving module, configured to receive the search request;
a searching module, configured to search for the destination address corresponding to the search request in the routing table according to the search request;
a determining module, configured to determine the memory corresponding to the destination address according to the destination address corresponding to the search request; and
a data receiving module, configured to receive the target data satisfying the search request from the memory.

11. The wireless sensor network according to claim 9, wherein each destination address in the routing table is corresponding to one memory.

12. The wireless sensor network according to claim 9, further comprising a plurality of types of sensors for collecting a plurality of types of data.

13. The wireless sensor network according to claim 12, wherein the data collected by each type of sensor is stored in the memory corresponding to the destination address of the data according to the routing table.

14. The wireless sensor network according to claim 9, wherein the plurality of data types comprises temperature, humidity, air pressure, wind power, illumination intensity, ultraviolet intensity, carbon dioxide concentration, air pollution index, toxic gas, noise, pressure, vibration, strain, displacement, velocity, heavy metal content, radiation value, electromagnetic radiation value, body temperature, blood pressure, heart rate, oxygen saturation, PH value and water soluble ion concentration.
